(19) United States
(12) Patent Application Publication
(10) Pub. No.: US 2013/0298650 A1
(43) Pub. Date: Nov. 14, 2013

(54) MOISTURE-SENSITIVE CERAMIC MATERIAL AND A MOISTURE-SENSITIVE CERAMIC ELEMENT

(71) Applicant: MURATA MUNUFACTURING CO., LTD., Nagaokakyo-Shi (JP)

(72) Inventor: Tadamasa Miura, Nagaokakyo-Shi (JP)

(21) Appl. No.: 13/944,199

(22) Filed: Jul. 17, 2013

Related U.S. Application Data
(63) Continuation of application No. PCT/JP2012/050772, filed on Jan. 17, 2012.

(30) Foreign Application Priority Data
Jan. 21, 2011 (JP) 2011-010502

(51) Int. Cl. C04B 35/50; G01N 27/22; G01N 27/04

(52) U.S. Cl. CPC C04B 35/50; G01N 27/048; G01N 27/223
USPC 73/73; 501/152; 501/134; 501/136; 501/135

(57) ABSTRACT

A moisture-sensitive ceramic material having a composition represented by the general formula RE(A,B)O₃, wherein RE is a rare earth element, A is a divalent metal element, and B is a tetravalent metal element. More specifically, the moisture-sensitive ceramic material has a composition represented by the general formula RE(A₁₋ₓBₓ)O₃, and A is Ni or Mg, and B is Ti or Sn.

### CROSS REFERENCE TO RELATED APPLICATIONS

The present application is a continuation of International application No. PCT/JP2012/050772, filed Jan. 17, 2012, which claims priority to Japanese Patent Application No. 2011-010502, filed Jan. 21, 2011, the entire contents of each of which are incorporated herein by reference.

### FIELD OF THE INVENTION

The present invention relates to a moisture-sensitive ceramic material and a moisture-sensitive ceramic element constructed by using the same.

### BACKGROUND OF THE INVENTION

One of the items for environmental sensing is “humidity”. The humidity sensing is used in an air-conditioning controlling apparatus in architectural structures, home electric appliances such as an air conditioner, a humidifier, a dehumidifier, and a drier, and the like. In the future, it is expected that the use of humidity sensing will be extended further to the field of health care (life environment monitoring), logistics (monitoring at the time of transportation), and the like. In particular, in accordance with the development of ubiquitous society, there will be widening needs for giving such function to a portable apparatus, and it is also expected that the demands for scale reduction will be strengthened.

As the humidity sensor, those using a moisture-sensitive element of polymer type are prevalent in the market. However, there is a problem in that a moisture-sensitive element of polymer type cannot sufficiently meet the increasing demands for sensors being small in scale and having high reliability from now on. For example, in mounting a moisture-sensitive element on a portable apparatus or the like, the moisture-sensitive element is reflow-mounted on a substrate, however, since the moisture-sensitive element of polymer type has low heat resistance, a heat-insulating structure will be needed as a countermeasure against heat. For this reason, when a moisture-sensitive element of polymer type is used, a situation will be invited in which the overall dimension of the humidity sensor increases.

On the other hand, a moisture-sensitive element of ceramic type is excellent in that the heat-resistant characteristics of the moisture-sensitive element itself are high, as compared with the above-described moisture-sensitive element of polymer type. A moisture-sensitive element using a ceramic material is disclosed in some patent documents. For example, Japanese Patent Application Laid-open (JP-A) No. 62-223054 (Patent Document 1) discloses a moisture-sensitive element having a sintered porous film of perovskite type composite oxide represented by A₁₋ₓA′ₓB_{1-y}B′_{y}O₃ (wherein A represents any one kind of element selected from rare earth elements having an atomic number of 57 to 71; A′ represents any one kind of element selected from alkaline earth metals; B represents a cobalt element; and B′ represents any one kind of element selected from transition metal elements).

However, the moisture-sensitive elements using a ceramic material including those disclosed in the aforementioned Patent Document 1 commonly have the following problems.

(1) The change ratio of moisture sensitivity characteristics such as resistance and capacitance relative to the humidity change are comparatively small,

(2) the moisture sensitivity characteristics are non-linear, and

(3) there is a hysteresis in the moisture sensitivity characteristics, and the reproducibility at the time of repetitive use is comparatively poor.

Regarding the above (1), in order to measure the humidity with a good resolution, a sufficient gain must be obtained against the noise of the signals generated by various conditions such as the element and the circuit. For that purpose, it is desirable that the change in the characteristics (resistance and capacitance) of the moisture-sensitive element relative to the change in the humidity environment is large. In order to increase the gain, an amplification circuit or the like may be used, however, because of the circuit construction, problems are invited such as inhibition of scale reduction, increase in the electric power consumption, and rise in the costs. Also, when the inherent signals themselves are less than the noise, the problem cannot be solved even by the amplification.

Regarding the above (2), when the moisture sensitivity characteristics (resistance and capacitance) are non-linear, the humidity cannot be calculated simply by the change in the voltage signals, so that correspondence between the signals from the sensor and the humidity must be made by correction with a circuit or a microcomputer, for example. However, in order to carry out this measure, a separate circuit construction will be needed, thereby also inviting the problems such as inhibition of scale reduction, increase in the electric power consumption, and rise in the costs.

Regarding the above (3), in order to enable humidity sensing with good precision, a refreshing function for keeping the reproducibility is imparted, for example. However, for that purpose, a separate circuit construction will be needed, and in this case also, problems are invited such as inhibition of scale reduction, increase in the electric power consumption, and rise in the costs.

From the above, almost all of the moisture-sensitive elements that are currently put into practical use are of polymer type, and it is a current situation that, in the market, use of the moisture-sensitive elements using a ceramic material in a portable apparatus is extremely limitative.

However, when the problems (1) to (3) as described above can be solved in a moisture-sensitive element using a ceramic material, it is expected that the future commercial demands can be sufficiently met by exhibiting a potential of inherently high heat-resistant characteristics.
Patent Document 1: Japanese Patent Application Laid-open (JP-A) No. 62-223054

### SUMMARY OF THE INVENTION

Thus, an object of the present invention is to provide a novel moisture-sensitive ceramic material having a sufficiently large change ratio of moisture sensitivity characteristics relative to the humidity change, being excellent in linearity of the moisture sensitivity characteristics, having a smaller hysteresis in the moisture sensitivity characteristics, and having good reproducibility at the time of repetitive use, as well as a moisture-sensitive ceramic element constructed by using the same.

The moisture-sensitive ceramic material according to the present invention is characterized by having a composition represented by the general formula: RE(A,B)O₃ (RE is a rare earth element, A is a divalent metal element, and B is a tetravalent metal element).

The moisture-sensitive ceramic material according to the present invention preferably has a composition represented by the general formula: RE(A₁₋ₓBₓ)O₃. Further, in this general formula, it is particularly preferable that

(1) A is Ni and B is Ti,

(2) A is Mg and B is Ti,

(3) A is Ni and B is Sn, or

(4) A is Mg and B is Sn.

The present invention is also directed to a moisture-sensitive ceramic element including: an element main body made of the above-described moisture-sensitive ceramic material and at least a pair of electrodes formed to interpose at least a part of the element main body therebetween.

According to the present invention, it is possible to obtain a moisture-sensitive ceramic material having a sufficiently large change ratio of moisture sensitivity characteristics relative to the humidity change, being excellent in linearity of the moisture sensitivity characteristics, having a smaller hysteresis in the moisture sensitivity characteristics, and having good reproducibility at the time of repetitive use.

More specifically, according to the moisture-sensitive ceramic material of the present invention, a resistance change ratio in the order of 0.5 digit or more is obtained by a change in the relative humidity from 30% to 80%, and also a relationship of a high linearity can be obtained in the humidity/log R.

Therefore, according to the present invention, it is possible to obtain a moisture-sensitive ceramic element that can be greatly expected to be used in a portable apparatus.

### BRIEF EXPLANATION OF THE DRAWINGS

FIG. 1 is a perspective view illustrating an appearance of a moisture-sensitive ceramic element 1 according to one embodiment of the present invention.

FIG. 2 is a graph showing the moisture sensitivity characteristics of a sample 74 obtained in an experiment example.

### DETAILED DESCRIPTION OF THE INVENTION

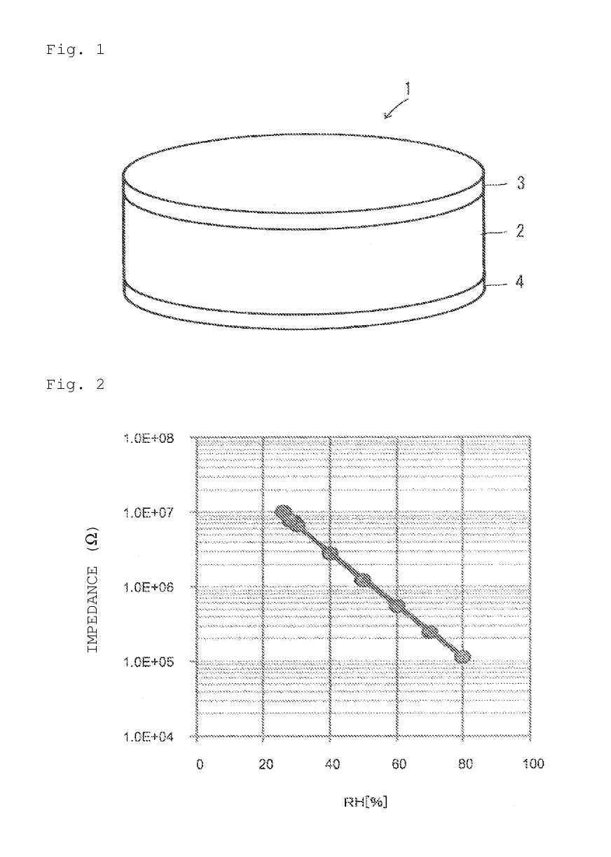

With reference to FIG. 1, a moisture-sensitive ceramic element 1 according to one embodiment of the present invention will be described.

The moisture-sensitive ceramic element 1 includes an element main body 2 made of a moisture-sensitive ceramic material and a pair of electrodes 3 and 4 that are respectively formed on opposite principal surfaces of the element main body 2.

The moisture-sensitive ceramic material constituting the element main body 2 has a composition represented by the general formula: RE(A,B)O₃ (RE is a rare earth element, A is a divalent metal element, and B is a tetravalent metal element).

In more specific embodiments, the aforementioned moisture-sensitive ceramic material has a composition represented by the general formula: RE(A₁₋ₓBₓ)O₃, and preferably there can be a case in which (1) A is Ni and B is Ti, (2) A is Mg and B is Ti, (3) A is Ni and B is Sn, and (4) A is Mg and B is Sn.

Hereafter, by way of an experiment example, the moisture-sensitive ceramic material according to the present invention will be more specifically described including the characteristics thereof.

First, each powder of RE₂O₂ (RE is a rare earth metal element from La having an atomic number of 57 to Yb having an atomic number of 70), NiO, MgO, TiO₂, and SnO₂ as a ceramic source material.

Subsequently, each powder constituting the above ceramic source material was weighed so as to attain a molar ratio shown in Tables 1 to 4, and these weighed materials were put into a ball mill together with a crushing medium made of zirconia and were sufficiently subjected to wet crushing, followed by performing a calcining treatment at a temperature of 1200° C. for 2 hours, thereby to obtain a ceramic powder that would be a moisture-sensitive ceramic material of each sample.

Next, an organic binder was added to the above ceramic powder and the resultant was subjected to a wet mixing process to form a slurry. Thereafter, this was dried and, after drying, the resultant was subjected to a mesh pass of #50 to obtain a powder. Further, dry pressing was applied to this powder to obtain a molded body having a disk shape and having a dimension with a diameter of 10 mm and a thickness of 1.5 mm.

Next, the obtained molded body having a disk shape was housed into a sagger made of zirconia, and a binder removal treatment was carried out at a temperature of 350° C. for 5 hours. Thereafter, a firing treatment was carried out at a temperature of 1300° C. for 5 hours in the atmospheric air to obtain an element main body made of a moisture-sensitive ceramic material according to each sample.

Next, an In—Ga electrode was formed by a coating method on both surfaces of the above element main body to complete a moisture-sensitive ceramic element serving as each sample.

With respect to the moisture-sensitive ceramic element obtained in this manner, impedance characteristics were measured while changing the relative humidity within a range of 30% to 80% at a temperature of 25° C. The impedance measurement was carried out using an LCR meter (4284A manufactured by Agilent Co., Ltd.). The measurement frequency was set to be 1 kHz.

The moisture-sensitivity characteristics were evaluated by calculating the following numerical values from the obtained result of measuring the impedance relative to the humidity.

(1) Impedance change ratio relative to the humidity change: Log(Z₃₀/Z₈₀)

Here, Z₃₀ and Z₈₀ are as follows:

Z₃₀: impedance of the element at a relative humidity of 30%

Z₈₀: impedance of the element at a relative humidity of 80%

(2) Linear coefficient R² of humidity-impedance: S_{xy}²/(Sₓₓ·S_{yy})

Here, S_{xy}, Sₓₓ, and S_{yy} are as follows:

S_{xy}=Σ(xᵢ−x)(yᵢ−y)

Sₓₓ=Σ(xᵢ−x)²

S_{yy}=Σ(yᵢ−y)²

In the above formulae, the x component is a value of the relative humidity; the y component is a logarithmic value Log Z of the impedance Z at each humidity; x is an average value of the x component; and y is an average value of the y component.

Also, xᵢ and yₓ are as follows.

xᵢ: relative humidity value (30, 40, 50, 60, 70, or 80) (%)

yᵢ: logarithmic value (Log Z₃₀, Log Z₄₀, Log Z₅₀, Log Z₆₀, Log Z₇₀, or Log Z₈₀) of the impedance Z at a relative humidity of 30%, 40%, 50%, 60%, 70%, or 80%

(3) Hysteresis [%] of the moisture sensitivity characteristics: (Z₀−Z₁₀)/Z₀×100

Here, Z₀ and Z₁₀ are as follows:

Z₀: initial impedance at a relative humidity of 30%

Z₁₀: impedance at a relative humidity of 30% after a process of changing the relative humidity as 30% [symbol] 40% [symbol] 50% [symbol] 60% [symbol] 70% [symbol] 80% [symbol] 70% [symbol] 60% [symbol] 50% [symbol] 40% [symbol] 30% for each cycle is repeated for 10 cycles

The above numerical values of (1) to (3) showing the moisture-sensitivity characteristics are shown in Tables 1 to 4. In Tables 1 to 4, the “impedance change ratio” corresponds to the above “(1) Impedance change ratio relative to the humidity change: Log(Z₃₀/Z₈₀)”; the “correlation function R² between humidity and Log R” corresponds to the above “(2) Linear coefficient R² of humidity-impedance: S_{xy}²/(Sₓₓ·S_{yy})”; and the “hysteresis” corresponds to the above “(3) Hysteresis [%] of the moisture sensitivity characteristics: (Z₀−Z₁₀)/Z₀×100”.

Here, in the “impedance change ratio” of Tables 1 to 4, the samples in which the numerical value became “0.05” or below or became negative are denoted with the symbol “−” and, with respect to these samples, the “correlation function R² between humidity and Log R” and the “hysteresis” were not determined and are likewise denoted with the symbol “−”.

The moisture sensitivity characteristics of the RE(Ni₁₋ₓTiₓ)O₃ composition are shown in Table 1.

TABLE 1

| | | | | | | | | | Correlation | |
|---|---|---|---|---|---|---|---|---|---|---|
| | | | | | | | | | function R² | |
| | RE | | | | | | | Impedance | between | |
| sample | La | Nd | Gd | Dy | Er | Ni | Ti | change | humidity | Hysteresis |
| number | mol | mol | mol | mol | mol | mol | mol | ratio | and LogR | [%] |
| 1 | 1.00 | | | | | 0.50 | 0.50 | — | — | — |
| 2 | | 1.00 | | | | 0.50 | 0.50 | — | — | — |
| 3 | | | 1.00 | | | 0.50 | 0.50 | — | — | — |
| 4 | | | | 1.00 | | 0.50 | 0.50 | 1.42 | 1.00 | 8.40 |
| 5 | | | | | 1.00 | 0.50 | 0.50 | 1.71 | 1.00 | 15.10 |
| 6 | 1.00 | | | | | 0.60 | 0.40 | — | — | — |
| 7 | 1.00 | | | | | 0.50 | 0.50 | — | — | — |
| 8 | 1.00 | | | | | 0.40 | 0.60 | — | — | — |
| 9 | 1.00 | | | | | 0.30 | 0.70 | — | — | — |
| 10 | 1.00 | | | | | 0.20 | 0.80 | — | — | — |
| 11 | 1.00 | | | | | 0.10 | 0.90 | 0.31 | 0.82 | 0.55 |
| 12 | 1.00 | | | | | 0 | 1.00 | 0.51 | 0.88 | 0.78 |
| 13 | | 1.00 | | | | 0.60 | 0.40 | — | — | — |
| 14 | | 1.00 | | | | 0.50 | 0.50 | — | — | — |
| 15 | | 1.00 | | | | 0.40 | 0.60 | — | — | — |
| 16 | | 1.00 | | | | 0.30 | 0.70 | — | — | — |
| 17 | | 1.00 | | | | 0.20 | 0.80 | 0.75 | 0.98 | 0.30 |
| 18 | | 1.00 | | | | 0.10 | 0.90 | 1.11 | 0.97 | 0.42 |
| 19 | | 1.00 | | | | 0.00 | 1.00 | 0.41 | 0.91 | 0.66 |
| 20 | | | 1.00 | | | 0.60 | 0.40 | — | — | — |
| 21 | | | 1.00 | | | 0.50 | 0.50 | 1.64 | 1.00 | 7.07 |
| 22 | | | 1.00 | | | 0.40 | 0.60 | 1.67 | 1.00 | 3.80 |
| 23 | | | 1.00 | | | 0.30 | 0.70 | 1.67 | 1.00 | 10.80 |
| 24 | | | 1.00 | | | 0.20 | 0.80 | 1.60 | 1.00 | 6.15 |
| 25 | | | 1.00 | | | 0.10 | 0.90 | 0.75 | 0.98 | 2.55 |
| 26 | | | 1.00 | | | 0 | 1.00 | 0.44 | 0.92 | 1.25 |
| 27 | | | | 1.00 | | 0.60 | 0.40 | — | — | — |
| 28 | | | | 1.00 | | 0.50 | 0.50 | 1.42 | 1.00 | 8.40 |
| 29 | | | | 1.00 | | 0.40 | 0.60 | 1.35 | 1.00 | 3.95 |
| 30 | | | | 1.00 | | 0.30 | 0.70 | 1.57 | 1.00 | 1.11 |
| 31 | | | | 1.00 | | 0.20 | 0.80 | 1.25 | 1.00 | 1.01 |
| 32 | | | | 1.00 | | 0.10 | 0.90 | 1.02 | 0.97 | 0.99 |
| 33 | | | | 1.00 | | 0.00 | 1.00 | 0.68 | 0.95 | 0.81 |
| 34 | | | | | 1.00 | 0.60 | 0.40 | — | — | — |
| 35 | | | | | 1.00 | 0.50 | 0.50 | 1.71 | 1.00 | 15.10 |
| 36 | | | | | 1.00 | 0.40 | 0.60 | 1.55 | 1.00 | 4.50 |
| 37 | | | | | 1.00 | 0.30 | 0.70 | 1.77 | 1.00 | 1.36 |
| 38 | | | | | 1.00 | 0.20 | 0.80 | 1.45 | 1.00 | 1.17 |
| 39 | | | | | 1.00 | 0.10 | 0.90 | 1.12 | 0.97 | 1.02 |
| 40 | | | | | 1.00 | 0 | 1.00 | 0.88 | 0.95 | 0.88 |
| 41 | | | | 0.99 | | 0.45 | 0.55 | 1.62 | 1.00 | 3.22 |
| 42 | | | | 0.99 | | 0.50 | 0.50 | 1.51 | 1.00 | 7.40 |
| 43 | | | | 0.99 | | 0.55 | 0.45 | — | — | — |
| 44 | | | | 1.00 | | 0.45 | 0.55 | 1.67 | 1.00 | 2.11 |
| 45 | | | | 1.00 | | 0.50 | 0.50 | 1.42 | 1.00 | 8.40 |
| 46 | | | | 1.00 | | 0.55 | 0.45 | — | — | — |
| 47 | | | | 1.01 | | 0.45 | 0.55 | 1.62 | 1.00 | 0.07 |
| 48 | | | | 1.01 | | 0.50 | 0.50 | 1.43 | 1.00 | 10.10 |
| 49 | | | | 1.01 | | 0.55 | 0.45 | — | — | — |
| 50 | | | | | 0.99 | 0.45 | 0.55 | 1.67 | 1.00 | 4.12 |
| 51 | | | | | 0.99 | 0.50 | 0.50 | 1.77 | 1.00 | 14.60 |
| 52 | | | | | 0.99 | 0.55 | 0.45 | 0.40 | 0.90 | 1.87 |
| 53 | | | | | 1.00 | 0.45 | 0.55 | 1.58 | 1.00 | 4.59 |
| 54 | | | | | 1.00 | 0.50 | 0.50 | 1.71 | 1.00 | 15.10 |
| 55 | | | | | 1.00 | 0.55 | 0.45 | 0.45 | 0.90 | 0.08 |
| 56 | | | | | 1.01 | 0.45 | 0.55 | 1.56 | 1.00 | 0.09 |
| 57 | | | | | 1.01 | 0.50 | 0.50 | 1.83 | 1.00 | 16.60 |
| 58 | | | | | 1.01 | 0.55 | 0.45 | 0.45 | 0.91 | 0.24 |

In the RE(Ni₁₋ₓTiₓ)O₃ composition, when the composition has a higher Ti ratio, a moisture-sensitive ceramic material having a larger resistance change ratio relative to the humidity, that is, having a larger “impedance change ratio”, tends to be obtained. In particular, good moisture sensitivity characteristics are obtained in the samples containing Dy or Er having a comparatively small atomic radius among the rare earth elements RE.

On the other hand, the cause of “hysteresis” is determined depending on whether the adsorbed moisture can be desorbed or not. Therefore, there are cases in which, when the resistance change is large, the “hysteresis” conversely becomes poor because the moisture adsorption is large in amount. However, the mechanism for adsorption and desorption of moisture has not been made clear yet.

Next, the moisture sensitivity characteristics of the RE(Mg₁₋ₓTiₓ)O₃ composition are shown in Table 2.

TABLE 2

| | | | | | | | | | Correlation | |
|---|---|---|---|---|---|---|---|---|---|---|
| | | | | | | | | | function R² | |
| | RE | | | | | | | Impedance | between | |
| sample | La | Nd | Gd | Dy | Er | Mg | Ti | change | humidity | Hysteresis |
| number | mol | mol | mol | mol | mol | mol | mol | ratio | and LogR | [%] |
| 59 | 1.00 | | | | | 0.50 | 0.50 | 1.68 | 0.97 | 0.64 |
| 60 | | 1.00 | | | | 0.10 | 0.90 | 1.77 | 0.98 | 2.02 |
| 61 | | 1.00 | | | | 0.30 | 0.70 | 1.93 | 0.99 | 0.28 |
| 62 | | 1.00 | | | | 0.50 | 0.50 | 2.04 | 0.99 | 0.53 |
| 63 | | 1.00 | | | | 0.60 | 0.40 | 2.19 | 0.99 | 1.62 |
| 64 | | 1.00 | | | | 0.75 | 0.25 | 2.30 | 0.99 | 0.59 |
| 65 | | 1.00 | | | | 0.90 | 0.10 | 2.34 | 1.00 | 1.03 |
| 66 | | | 1.00 | | | 0.10 | 0.90 | 1.02 | 0.96 | 0.40 |
| 67 | | | 1.00 | | | 0.30 | 0.70 | 2.31 | 0.99 | 1.06 |
| 68 | | | 1.00 | | | 0.60 | 0.40 | 2.24 | 0.99 | 0.36 |
| 69 | | | 1.00 | | | 0.90 | 0.10 | 1.91 | 0.98 | 0.41 |
| 70 | | | | 1.00 | | 0.10 | 0.90 | 0.37 | 0.85 | 0.10 |
| 71 | | | | 1.00 | | 0.20 | 0.80 | 1.58 | 0.98 | 1.22 |
| 72 | | | | 1.00 | | 0.30 | 0.70 | 1.40 | 0.86 | 0.06 |
| 73 | | | | 1.00 | | 0.40 | 0.60 | 1.75 | 0.96 | 0.34 |
| 74 | | | | 1.00 | | 0.50 | 0.50 | 1.77 | 1.00 | 0.65 |
| 75 | | | | 1.00 | | 0.60 | 0.40 | 2.51 | 1.00 | 0.76 |
| 76 | | | | 1.00 | | 0.70 | 0.30 | 2.55 | 0.99 | 3.15 |
| 77 | | | | 1.00 | | 0.80 | 0.20 | 2.40 | 1.00 | 2.53 |
| 78 | | | | 1.00 | | 0.90 | 0.10 | 2.38 | 1.00 | 2.19 |
| 79 | | | | 1.00 | | 1.00 | 0 | 2.41 | 1.00 | 7.91 |
| 80 | | | | | 1.00 | 0.50 | 0.50 | 1.62 | 0.98 | 0.09 |

In the RE(Mg₁₋ₓTiₓ)O₃ composition, there is no specific tendency between the Ti ratio and the resistance change ratio (“impedance change ratio”) relative to the humidity; however, the “impedance change ratio” tends to be large as compared with the above-described case of the RE(Ni₁₋ₓTiₓ)O₃ composition containing Ni instead of Mg. Also, good moisture sensitivity characteristics are obtained irrespective of the atomic radius of the rare earth element RE.

Here, as a representative of the samples fabricated in this experiment example, the moisture sensitivity characteristics of the sample 74 with the Dy_{1.00}(Mg_{0.50}Ti_{0.50})O₃ composition shown in Table 2 are shown in FIG. 2. As will be understood from FIG. 2, a moisture-sensitive ceramic material exhibiting a resistance change in the order of one digit or more relative to the humidity change and having moisture sensitivity characteristics with high linearity and with a smaller hysteresis is obtained.

Next, the moisture sensitivity characteristics of the RE(Ni₁₋ₓSnₓ)O₃ composition are shown in Table 3.

TABLE 3

| | | | | | | | | | Correlation | |
|---|---|---|---|---|---|---|---|---|---|---|
| | | | | | | | | | function R² | |
| | RE | | | | | | | Impedance | between | |
| sample | La | Nd | Gd | Dy | Er | Ni | Sn | change | humidity | Hysteresis |
| number | mol | mol | mol | mol | mol | mol | mol | ratio | and LogR | [%] |
| 81 | 1.00 | | | | | 0.50 | 0.50 | — | — | — |
| 82 | | 1.00 | | | | 0.50 | 0.50 | — | — | — |
| 83 | | | 1.00 | | | 0.50 | 0.50 | 3.16 | 0.99 | 1.39 |
| 84 | | | | 1.00 | | 0.50 | 0.50 | 2.46 | 0.99 | 0.44 |
| 85 | | | | | 1.00 | 0.00 | 1.00 | 2.33 | 0.99 | 0.48 |
| 86 | | | | | 1.00 | 0.10 | 0.90 | 1.11 | 0.90 | 0.65 |
| 87 | | | | | 1.00 | 0.20 | 0.80 | 1.25 | 0.90 | 0.55 |
| 88 | | | | | 1.00 | 0.30 | 0.70 | 1.29 | 0.90 | 0.21 |
| 89 | | | | | 1.00 | 0.40 | 0.60 | 1.94 | 1.00 | 3.94 |
| 90 | | | | | 1.00 | 0.50 | 0.50 | 1.92 | 1.00 | 2.84 |
| 91 | | | | | 1.00 | 0.60 | 0.40 | 2.04 | 1.00 | 0.93 |
| 92 | | | | | 1.00 | 0.70 | 0.30 | 2.12 | 1.00 | 0.98 |
| 93 | | | | | 1.00 | 0.80 | 0.20 | 1.29 | 0.90 | 0.21 |
| 94 | | | | | 1.00 | 0.90 | 0.10 | 1.08 | 0.93 | 0.52 |
| 95 | | | | | 1.00 | 1.00 | 0.00 | 0.64 | 0.89 | 1.11 |

In the RE(Ni₁₋ₓSnₓ)O₃ composition, there is no specific tendency between the Sn ratio and the resistance change ratio (“impedance change ratio”) relative to the humidity; however, the change ratio tends to be large as compared with the above-described case of the RE(Ni₁₋ₓTiₓ)O₃ composition containing Ti instead of Sn. Also, good moisture sensitivity characteristics are obtained in the samples containing Dy or Er having a comparatively small atomic radius among the rare earth elements RE.

Next, the moisture sensitivity characteristics of the RE(Mg₁₋ₓSnₓ)O₃ composition are shown in Table 4.

TABLE 4

| | | | | | | | | | Correlation | |
|---|---|---|---|---|---|---|---|---|---|---|
| | | | | | | | | | function R² | |
| | RE | | | | | | | Impedance | between | |
| sample | La | Nd | Gd | Dy | Er | Mg | Sn | change | humidity | Hysteresis |
| number | mol | mol | mol | mol | mol | mol | mol | ratio | and LogR | [%] |
| 96 | 1.00 | | | | | 0.25 | 0.75 | 2.42 | 1.00 | 5.11 |
| 97 | 1.00 | | | | | 0.50 | 0.50 | 2.32 | 0.99 | 4.39 |
| 98 | 1.00 | | | | | 0.75 | 0.25 | 2.01 | 0.99 | 0.89 |
| 99 | | 1.00 | | | | 0.25 | 0.75 | 2.51 | 1.00 | 2.55 |
| 100 | | 1.00 | | | | 0.50 | 0.50 | 2.49 | 0.99 | 1.81 |
| 101 | | 1.00 | | | | 0.75 | 0.25 | 2.03 | 1.00 | 1.01 |
| 102 | | | 1.00 | | | 0.25 | 0.75 | 2.61 | 1.00 | 1.55 |
| 103 | | | 1.00 | | | 0.50 | 0.50 | 2.52 | 0.99 | 0.35 |
| 104 | | | 1.00 | | | 0.75 | 0.25 | 2.02 | 0.99 | 0.55 |
| 105 | | | | 1.00 | | 0.25 | 0.75 | 2.61 | 1.00 | 1.44 |
| 106 | | | | 1.00 | | 0.50 | 0.50 | 2.51 | 0.99 | 1.77 |
| 107 | | | | 1.00 | | 0.75 | 0.25 | 2.00 | 0.99 | 0.15 |
| 108 | | | | | 1.00 | 0.10 | 0.90 | 2.00 | 1.00 | 4.18 |
| 109 | | | | | 1.00 | 0.20 | 0.80 | 2.54 | 0.99 | 1.13 |
| 110 | | | | | 1.00 | 0.30 | 0.70 | 2.45 | 0.99 | 1.35 |
| 111 | | | | | 1.00 | 0.40 | 0.60 | 2.48 | 0.99 | 1.56 |
| 112 | | | | | 1.00 | 0.50 | 0.50 | 2.51 | 0.99 | 1.65 |
| 113 | | | | | 1.00 | 0.60 | 0.40 | 2.47 | 0.98 | 0.47 |
| 114 | | | | | 1.00 | 0.70 | 0.30 | 1.81 | 1.00 | 0.09 |
| 115 | | | | | 1.00 | 0.80 | 0.20 | 1.99 | 1.00 | 0.25 |
| 116 | | | | | 1.00 | 0.90 | 0.10 | 2.66 | 0.99 | 1.32 |
| 117 | | | | | 1.00 | 1.00 | 0.00 | 2.66 | 0.99 | 2.21 |

In the RE(Mg₁₋ₓSnₓ)O₃ composition, there is no specific tendency between the Sn ratio and the resistance change ratio (“impedance change ratio”) relative to the humidity; however, the “impedance change ratio” tends to be large as compared with the above-described case of the RE(Mg₁₋ₓTiₓ)O₃ composition containing Ti instead of Sn. Also, good moisture sensitivity characteristics are obtained irrespective of the atomic radius of the rare earth element RE.

### DESCRIPTION OF REFERENCE SYMBOLS

1 moisture-sensitive ceramic element
2 element main body
3, 4 electrode

1. A moisture-sensitive ceramic material having a composition represented by the general formula: RE(A,B)O₃, wherein RE is a rare earth element, A is a divalent metal element, and B is a tetravalent metal element.

2. The moisture-sensitive ceramic material according to claim 1, wherein the composition is represented by the general formula RE(Ni₁₋ₓTiₓ)O₃.

3. The moisture-sensitive ceramic material according to claim 2, wherein RE is selected from the group consisting of Dy and Er. (from new paragraph [0057])

4. The moisture-sensitive ceramic material according to claim 1, wherein the composition is represented by the general formula RE(Mg₁₋ₓTiₓ)O₃.

5. The moisture-sensitive ceramic material according to claim 4, wherein RE is selected from the group consisting of La, Nd, Gd, Dy and Er. (from new paragraph [0061])

6. The moisture-sensitive ceramic material according to claim 4, wherein the composition is represented by the general formula Dy_{1.00}(Mg_{0.50}Ti_{0.50})O₃. (from new paragraph [0062])

7. The moisture-sensitive ceramic material according to claim 1, wherein the composition is represented by the general formula RE(Ni₁₋ₓSnₓ)O₃.

8. The moisture-sensitive ceramic material according to claim 7, wherein RE is selected from the group consisting of Dy and Er. (from new paragraph [0065])

9. The moisture-sensitive ceramic material according to claim 1, wherein the composition is represented by the general formula RE(Mg₁₋ₓSnₓ)O₃.

10. The moisture-sensitive ceramic material according to claim 9, wherein RE is selected from the group consisting of La, Nd, Gd, Dy and Er. (from new paragraph [0068])

11. The moisture-sensitive ceramic material according to claim 1, wherein RE is selected from the group consisting of La, Nd, Gd, Dy and Er. (from Tables 1, 2, 3 and 4)

12. The moisture-sensitive ceramic material according to claim 11, wherein A is selected from the group consisting of Ni and Mg, and B is selected from the group consisting of Ti and Sn. (from new paragraph [0028])

13. The moisture-sensitive ceramic material according to claim 1, wherein A is selected from the group consisting of Ni and Mg, and B is selected from the group consisting of Ti and Sn. (from new paragraph [0028])

14. The moisture-sensitive ceramic material according to claim 1, wherein the composition is represented by the general formula RE(A₁₋ₓBₓ)O₃. (from new paragraph [0028])

15. The moisture-sensitive ceramic material according to claim 14, wherein RE is selected from the group consisting of La, Nd, Gd, Dy and Er. (from Tables 1, 2, 3 and 4)

16. The moisture-sensitive ceramic material according to claim 15, wherein A is selected from the group consisting of Ni and Mg, and B is selected from the group consisting of Ti and Sn. (from new paragraph [0028])

17. The moisture-sensitive ceramic material according to claim 14, wherein A is selected from the group consisting of Ni and Mg, and B is selected from the group consisting of Ti and Sn. (from new paragraph [0028])

18. A moisture-sensitive ceramic element comprising:
an element main body made of the moisture-sensitive ceramic material according to claim 1; and
at least a pair of electrodes on opposed sides of the element main body.

19. The moisture-sensitive ceramic material according to claim 8, wherein the pair of electrodes comprise an In—Ga material. (from new paragraph [0034])
